(19) United States
(12) Patent Application Publication
(10) Pub. No.: US 2025/0183808 A1
(43) Pub. Date: Jun. 5, 2025

(54) SELECTIVE SECONDARY PHASE-SHIFTING CONTROL FOR RESONANT CONVERTERS

(71) Applicant: VIRGINIA TECH INTELLECTUAL PROPERTIES, INC., Blacksburg, VA (US)

(72) Inventors: Pranav Raj Prakash, Blacksburg, VA (US); Ahmed Nabih, Richardson, TX (US); Qiang Li, Blacksburg, VA (US)

(21) Appl. No.: 18/967,952

(22) Filed: Dec. 4, 2024

Related U.S. Application Data
(60) Provisional application No. 63/605,857, filed on Dec. 4, 2023.

(51) Int. Cl. H02M 3/335; H02M 3/00

(52) U.S. Cl. CPC H02M 3/3353; H02M 3/01; H02M 3/33571; H02M 3/33576

(57) ABSTRACT

An example power converter system includes an input and an output and a power converter between the input and the output. The power converter includes a transformer including N elemental transformers, primary-side switches coupled to a primary side of the transformer and operating based on a primary-side switching operation, and secondary-side switches coupled to each elemental transformer among the N elemental transformers at a secondary side of the transformer. The system further includes a controller configured to generate switching control signals for each secondary-side switches such that a switching operation in at least one elemental transformer among the N elemental transformers is phase-shifted with respect to the primary-side switching operation, while a switching operation in at least one different elemental transformer among the N elemental transformers is in-phase with respect to the primary-side switching operation.

### CROSS-REFERENCE TO RELATED APPLICATION

This application claims the benefit of and priority to U.S. Provisional Patent Application No. 63/605,857, filed Dec. 4, 2023, entitled “SELECTIVE SECONDARY PHASE-SHIFTING CONTROL FOR RESONANT CONVERTERS,” the entire content of which is hereby incorporated herein by reference in its entirety.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Many applications, such as datacenters, aerospace, automotive etc. require high-efficiency DC-DC converters that provide isolation to the load. Although many topologies are good candidates for this application, resonant converters are desirable due to their ability to achieve soft-switching for the primary and secondary devices. This enables the resonant frequency (fₒ), and hence the switching frequency (fₛ) to be increased, thereby reducing the size of the magnetic component, hence resulting in higher power densities. Numerous applications that employ resonant DC-DC converters require the output voltage/current to be regulated. In general, the gain of a resonant converter can be changed by altering the switching frequency (fₛ) away from the resonant frequency (fₒ). However, frequency modulation alone is often inadequate to achieve very wide gain ranges without (a) implementing a large resonant inductor Lᵣ, (b) operating over a very wide frequency range, and (c) sacrificing overall efficiency, especially at the nominal operating point. Special control techniques or topology modifications are therefore needed to mitigate these drawbacks.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an example power converter system according to various embodiments of the present disclosure.

FIG. 2 depicts a schematic of an example power converter that can be implemented in the system shown in FIG. 1 according to various embodiments of the present disclosure.

FIG. 3 depicts a waveform of switching operations of an example power converter implementing a selective secondary-side rectifier (SR) phase-shift control method, according to various embodiments of the present disclosure.

FIG. 4 depicts a waveform of switching operations of an example power converter implementing a first step of a hybrid selective SR phase-shift control method, according to various embodiments of the present disclosure.

FIG. 5 depicts a waveform of respective voltage levels in an example power converter with respect to the switching operations shown in FIG. 4, according to various embodiments of the present disclosure.

FIG. 6 depicts a waveform of switching operations of an example power converter implementing a second step of a hybrid selective SR phase-shift control method, according to various embodiments of the present disclosure.

FIG. 7 depicts a waveform of respective voltage levels in an example power converter with respect to the switching operations shown in FIG. 6, according to various embodiments of the present disclosure.

FIG. 8 depicts a schematic of an example power converter including three (3) elemental transformers that can be implemented in the system shown in FIG. 1, according to various embodiments of the present disclosure.

FIG. 9 depicts a schematic of an example power converter including four (4) elemental transformers that can be implemented in the system shown in FIG. 1, according to various embodiments of the present disclosure.

FIG. 10 depicts a schematic of an example power converter including a transformer with center-tap rectifiers which can be implemented in the power converter system shown in FIG. 1, according to various embodiments of the present disclosure.

FIG. 11 depicts a waveform of switching operations of an example power converter including a transformer with center-tap rectifiers, implementing a selective SR phase-shift control method, according to various embodiments of the present disclosure.

### DETAILED DESCRIPTION

Power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

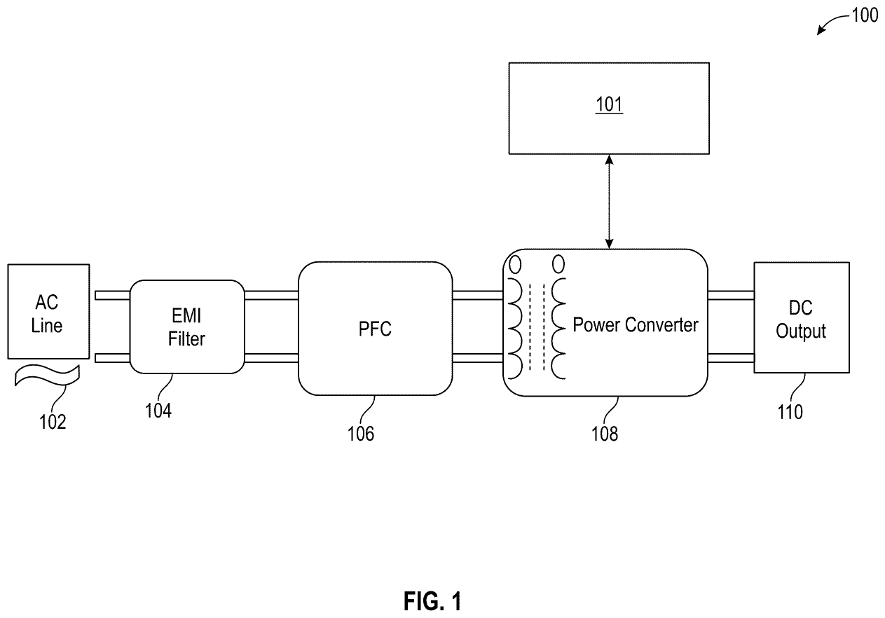

Various applications, including desktop, televisions, telecommunications, datacenters and electric vehicle charging, all are powered by off-line power supplies, which convert AC input to high-current DC output, and require an isolated DC/DC converter (FIG. 1). Furthermore, other applications such as in electric vehicles, isolated DC-DC converters are required as auxiliary power modules between the high voltage battery and low voltage loads and batteries.

An additional requirement for these applications often is a wide voltage gain range. For example, in off-line power supplies, the converter must maintain the rated output voltage during a certain hold-up time if the AC input cuts off, requiring the DC-DC to achieve a high voltage gain. For the auxiliary power supplies in electric vehicles on the other hand, the high-voltage and low-voltage batteries typically have a wide voltage range, which requires the DC-DC converter to operate over a wide gain range.

A range of isolated and non-isolated power converters are known. In isolated high power converters, especially those requiring high voltage step-down ratios, the secondary-side current is often too high for a single transformer to handle without incurring high losses. It is also common to have multiple secondary-side rectifiers (SRs) in a paralleled configuration in such high power converters with high voltage step-down ratios.

The converter specifications place a new challenge of having an isolated converter with a high voltage step-down ratio, high output current capability, high efficiency and high power density. Power converters including LLC resonant converters fit the profile for such applications. They can achieve zero voltage switching (ZVS) over the entire load range, have lower turn-off current for the primary switches (compared to soft-switching PWM converters) and achieve zero current switching (ZCS) for the SRs. With the advent of Gallium-Nitride (GaN) technology and developments in planar magnetics, the aim of pushing the efficiencies and power densities of power converters has become easier.

Power converters including LLC converters can operate at different modes within a switching cycle and each mode can output different levels of current through various primary-side transistors, secondary-side transistors, and the resonant tank circuit. Effectively controlling current flow through these components at the various modes can contribute to lower switching losses, lower turn-off loss, higher gain, and reduced frequency range operation along over an entire gain range, among other benefits.

To increase the voltage gain, conventional frequency modulation allows the magnetizing current to charge the resonant tank with the additional energy for increased gain when the converter is switched below the resonant frequency. However, this increases the circulating current during nominal operation, thereby reducing efficiency. Moreover, a smaller resonant capacitance can charge faster to reduce the frequency range, but the resonant inductance must be increased to maintain the same resonant frequency. Conventional SR phase-shift control for LLC converters with FB rectifiers includes phase shifting multiple transistors or multiple bridges simultaneously. This shorts the transformer secondary and bypasses the magnetizing inductance, thereby eliminating the dependance on the magnetizing current to increase the resonant tank energy. However, conventional control techniques can introduce a variety of redundant operations and unnecessarily high inductance levels for the resonant tank circuit, which can generate more heat, cause wide frequency range, and cause high SR turn-off loss.

The embodiments described herein are directed to SR control methods for LLC converters. In this context, the SR control methods contribute to, reduced frequency range operation over the entire gain range, lower SR turn-off losses, and higher primary turn-off currents to maintain ZVS, among other benefits. An example power converter system can include an input, an output, and a power converter that is connected between the input and the output. The power converter can include a transformer including N elemental transformers, primary-side switching devices or switches coupled to a primary side of the transformer and operating based on a primary-side switching operation, and secondary-side switching devices or switches coupled to each elemental transformer among the N elemental transformers at a secondary side of the transformer. The power converter system can further include a controller configured to generate switching control signals for each secondary-side switching devices such that a switching operation in at least one elemental transformer among the N elemental transformers is phase-shifted with respect to the primary-side switching operation, while a switching operation in at least one different elemental transformer among the N elemental transformers is in-phase with respect to the primary-side switching operation.

Referring now to the drawings, FIG. 1 depicts an example power converter system according to various embodiments of the present disclosure. Power converter system 100 includes an AC line 102, an electromagnetic interference (EMI) filter 104, a PFC stage 106, a power converter 108, a DC output 110, and a controller 101 configured to control the power converter 108. The power converter system 100 shown in FIG. 1 is not exhaustively illustrated, meaning that other components not shown in FIG. 1 can be included or relied upon in some cases. Similarly, one or more components shown in FIG. 1 can be omitted in some cases.

The power converter 108 can be embodied as a resonant LLC converter, as described below, and is a candidate for soft-switching for primary and secondary devices, has low primary turn-off loss, includes transformer-based isolation and step-down, and includes magnetic integration for high density applications, according to one example. However, it should be noted that the power converter 108 can be embodied as other types of power converters. The power converter 108 can include an isolated DC-DC converter and can be used in various applications such as automotive (EV), datacenters, telecom, LCD TVs, and computers, among others. The power converter 108 can be configured to receive an input from the AC line 102, which is fed via the EMI filter 104 and the PFC stage 106. The power converter 108 is configured to generate the DC output 110 based on switching control signals received from the controller 101. In various cases, the power converter 108 provides isolation to a load (not shown), which can be configured to receive the DC output 110.

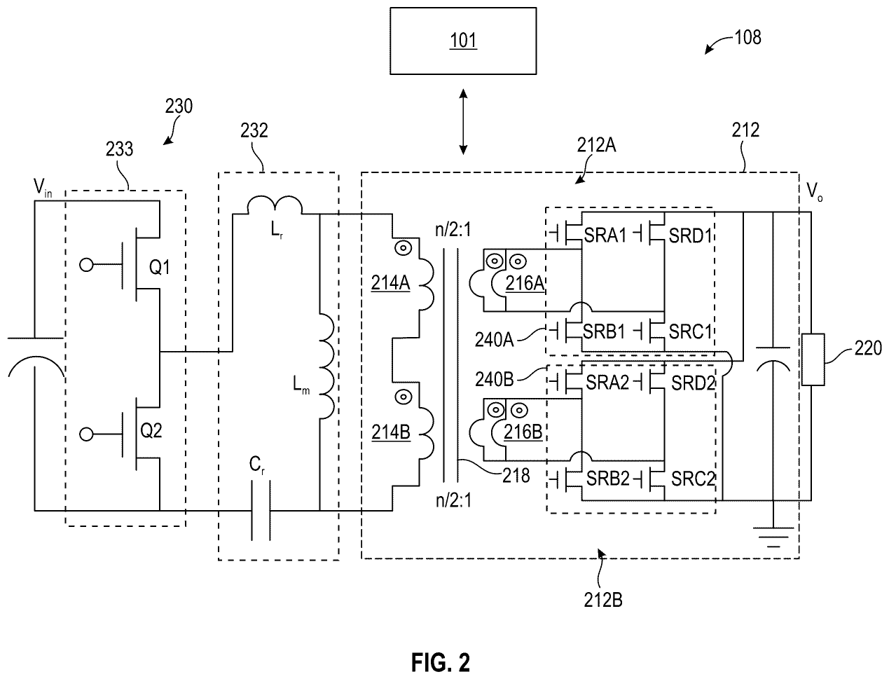

The power converter 108 can include various transformers and inverters. For example, the power converter 108 can include a resonant tank, a matrix transformer that includes N elemental transformers arranged in an array, and an inverter that is coupled to a primary side of the matrix transformer. Secondary-side switching transistors of each elemental transformer can be arranged as or form a full-bridge rectifier or a center-tap rectifier. The power converter 108 is configured to operate and generate an isolated DC voltage (e.g., step-up or step-down) for a load based on switching control signals received from the controller 101. A detailed description of the power converter 108 is provided with respect to FIG. 2, which is provided below.

The controller 101 is configured to generate switching control signals for the power converter 108. In various cases, the controller 101 is configured to generate switching control signals for the secondary-side switching transistors of the power converter 108 for selective SR phase-shift control, although the controller 101 can be configured to generate switching control signals for the primary-side switching transistors as well. Thus, the controller 101 can direct the switching (i.e., current or power flow) operation of the aforementioned switching devices or switches. Example operating frequencies for the power converter 108 can range from tens of kHz to several MHz or higher. The switching devices and operation of the power converter 108 can be controlled by pulse width modulation (PWM) control signals generated by the controller 101, according to one example.

The controller 101 can be embodied as processing circuitry, including memory, configured to control operation of the power converter 108, with or without feedback. The controller 101 can be embodied as any suitable type of controller, such as a proportional integral derivative (PID) controller, a proportional integral (PI) controller, or a multi-pole multi-zero controller, among others, to control the operations of the power converter 108. The controller 101 can be realized using a combination of processing circuitry and referenced as a single controller. It should be appreciated, however, that the controller 101 can be realized using a number of controllers, control circuits, drivers, and related circuitry, operating with or without feedback.

FIG. 2 depicts a schematic of an example power converter that can be implemented in the system shown in FIG. 1 according to various embodiments of the present disclosure. The power converter 108 includes an inverter 230, a resonant tank 232, and a transformer 212. The power converter 108 is configured to receive an input voltage (Vᵢₙ) from, for example, the PFC stage 106 and supply an output voltage (Vₒ) to a load 220 based on switching control signals received from the controller 101.

The transformer 212 can include a matrix transformer and other types of transformers. The transformer 212 can include N elemental transformers, where each elemental transformer can be arranged in an array. In the example shown in FIG. 2, the transformer 212 includes two (2) elemental transformers 212A and 212B, arranged in an array. The elemental transformer 212A can include primary winding 214A, secondary windings 216A, and secondary-side switching transistors 240A (“secondary-side switches 240A”), which include SRs SRA1, SRB1, SRD1, and SRC1. The elemental transformer 212B can include primary winding 214B, secondary windings 216B, and secondary-side switching transistors 240B (“secondary-side switches 240B”), which include SRs SRA2, SRB2, SRD2, and SRC2. The secondary-side switches 240A and 240B are each arranged in a full-bridge configuration.

The secondary-side switches 240A and 240B are connected to a secondary side of the transformer 212 at the secondary windings 216A and 216B. The primary windings 214A and 214B for the elemental transformers 212A and 212B can be connected in series to the resonant tank 232 during operation. The secondary-side switches 240A and 240B can be connected in parallel to, for example, the load 220 during operation. The transformer 212 further includes a core 218, which can be a UU or UI core according to one example, but the transformer 212 is not limited thereto. The secondary-side switches 240A and 240B can be embodied as metal-oxide-semiconductor field-effect transistors (MOSFETs) or high electron mobility transistors (HEMTs), among other switching devices. The transformer 212 can have a turns ratio between the primary windings 214A and 214B and the secondary windings 216A and 216B of n/2:1.

The inverter 230 includes primary-side switching transistors 233 (“primary-side switches 233”), which include switching transistors Q1 and Q2 connected to a primary side of the transformer 212 via the resonant tank 232. The primary-side switches 233 are configured in a half-bridge configuration but other configurations can be relied upon. The switches 233 can be embodied as MOSFETs or insulated gate bipolar transistors (IGBTs), among other switching devices. The resonant tank 232 can include a series resonant inductor (Lᵣ), a series resonant capacitor (Cᵣ), and a magnetizing inductance (Lₘ) connected between the transformer 212 and the inverter 230. Based on switching operations of the secondary-side switches 240A and 240B, which can be controlled by switching control signals received from the controller 101, charging speed and/or voltage levels of the resonant tank 232 can fluctuate, leading to more optimal operation of the power converter 108, such as reduced frequency range operation along over the entire gain range, among other benefits.

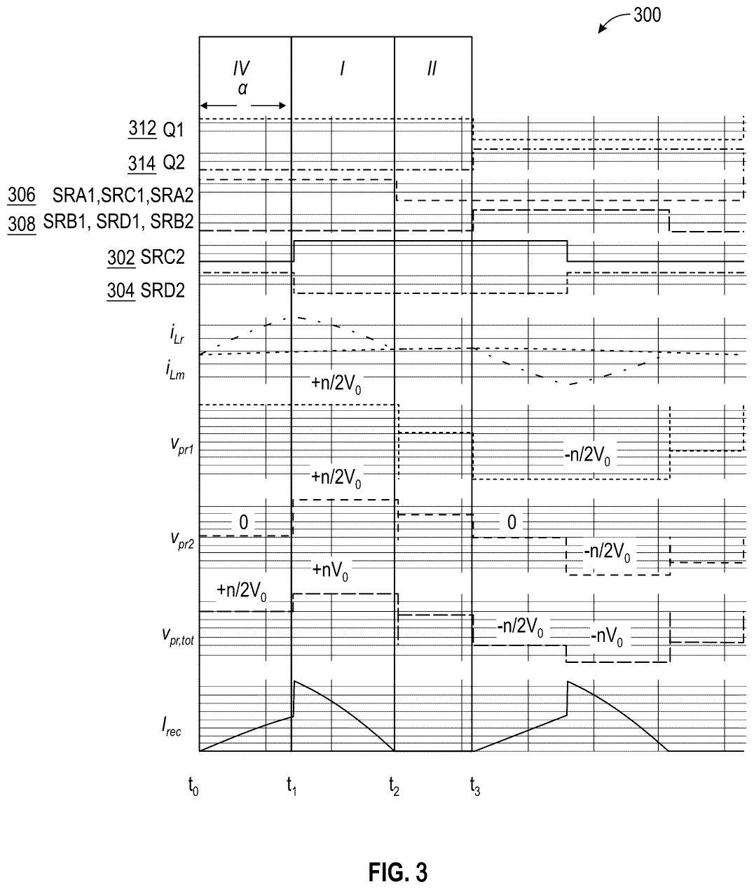

The controller 101 can be configured to selectively phase shift each of the secondary-side switches 240A or 240B with respect to switching operations of the primary-side switches 233, which can cause partial connection or selective connection of the load 220 to the elemental transformer 212A or the elemental transformer 212B during one or more portions of a switching cycle. In other words, either a switching operation of the secondary-side switches 240A is phase shifted with respect to a switching operation of the primary-side switches 233 or a switching operation of the secondary-side switches 240B is phase shifted with respect to the switching operation of the primary-side switches 233. To delineate further, phase shifting the switching operation of the secondary-side switches 240A or the secondary-side switches 240B can include phase shifting a switching operation of a respective half-bridge of the secondary-side switches 240A or the secondary-side switches 240B, with respect to the switching operation of the primary-side switches. This switching control method is described further with respect to the waveform of FIG. 3.

FIG. 3 depicts a waveform of switching operations of an example power converter implementing a selective SR phase-shift control method, according to various embodiments of the present disclosure. For example, waveform 300 depicts signals showing switching operations of the secondary-side switches 240A and 240B, switching operations of the primary-side switches 233, and impacted current and voltage levels in the power converter 108 based on the selective SR phase-shift control method. The waveform 300 corresponds to an operating example of the power converter 108 where the power converter 108, including the transformer 212, is operating based on conditions where a switching frequency (fₛ) equals the resonant frequency (fₒ), although other operating frequencies of the power converter 108 can be relied upon and are included within the embodiments covered by this disclosure.

In the example shown according to the waveform 300, the controller 101 can be configured to generate switching control signals for the power converter 108, such that switching operations of the secondary-side switches SRC2 and SRD2 (e.g., corresponding to the secondary-side switches 240B) are phase-shifted with respect to switching operations of the primary-side switches Q1 or Q2 of the primary-side switches 233. In the period corresponding to mode “IV” shown in the waveform 300, switching operation 302 for the switch SRC2 and switching operation 304 for the switch SRD2 are phase shifted with respect to switching operation 312 for the switch Q1. In other words, the switching operations 302 and 304 are phase-shifted by an angle of alpha (α) with respect to the switching operation 312, while switching operations 306 and 308 for the secondary-side switches SRA2, SRB2 (e.g., corresponding to the secondary-side switches 240B) and the secondary-side switches SRA1, SRB1, SRD1, and SRC1 (e.g., corresponding to the secondary-side switches 240A) are in-phase with the switching operation 312 and turned-off when the resonant current equals the magnetizing current to prevent reverse conduction.

In further detail, an operation of a half-bridge corresponding to the secondary-side switches SRD2 and SRC2 is phase shifted with respect to an operation of the primary-side switches 233, while a corresponding operation of the other half-bridge corresponding to the secondary-side switches SRA2 and SRB2 is not phase shifted and remain in-phase with the operation of the primary-side switches 233. Additionally, the full-bridge corresponding to the secondary-side switches 240A is not phase shifted and remains in-phase with the operation of the primary-side switches 233. The phase-shift angle α, which is defined as (t₁−t₀)/(t₃−t₀)*180° can range from 0-180°, which can cause the power converter 108 to achieve a max gain of 2 according to one example, but the power converter 108 is not limited thereto.

This mode of operation and selective SR phase-shifting can cause the load 220 to be partially or selectively connected to the elemental transformer 212A during operation of the power converter 108 in mode or period IV (e.g., t₀−t₁), as the elemental transformer 212B is effectively shorted in mode IV, as displayed by voltage level (Vₚᵣ₂) of zero (0), which corresponds to the voltage across the primary winding 214B. Voltage level (Vₚᵣ₁) corresponding to the voltage across the primary winding 214A is nonzero in mode IV, illustrating partial connection or selective connection of the load 220 via the elemental transformer 212A. Additionally, this mode of operation and selective SR phase-shifting can reduce voltage across the resonant tank 232, for example in mode IV, due to the partial connection or selective connection of the load 220. This is shown in the waveform 300 where voltage level (V_{pr,tot}), which is the total voltage across the transformer 212, is represented by (n/2Vₒ) in mode IV. This results in the voltage across the resonant tank 232 to be Vₜₐₙₖ=Vᵢₙ−n/2Vₒ in the half-cycle when Q1 is ON. It should be noted that in conventional methods, the load 220 may be disconnected in t₀−t₁, causing the voltage V_{pr,tot} to be 0, and hence Vₜₐₙₖ=Vᵢₙ.

Current (i_{LR}) represents peak current across the series resonant inductor (Lᵣ), current (i_{LM}) represents peak current across the magnetizing inductor (Lₘ), and current (I_{rec}) represents peak rectifier current across the load 220 for the different modes of operation of the power converter 108. By implementing the selective phase-shift control described above, peak currents across the series resonant inductor L, can be reduced and charging of the load 220 can be controlled.

In mode IV, the load 220 can be charged via the partial connection and the resonant tank 232 can be quickly charged. In mode I (e.g., t₀−t₁), the load 220 and the resonant tank 232 can be charged. In mode II (e.g., t₂−t₃), the load 220 is not charged and the resonant tank 232 can be slowly charged since Lm is part of the resonant tank. Modes IV-II correspond to half of a switching cycle for the primary-side switches 233 and the secondary-side switches 240A and 240B. After mode II, the controller 101 can be configured to generate switching control signals for the other half of the switching cycle for the primary-side switches 233 and the secondary-side switches 240A and 240B but in an inverted manner (e.g., selectively phase shifting with respect to switching operation 314 of the switch Q2), while implementing selective phase-shift control of one elemental transformer 212A or 212B.

Although the waveform 300 corresponds to the phase-shift of the operation of the secondary-side switches SRC2 and SRD2, the controller 101 can be configured to implement selective phase-shift for any half-bridge of the secondary-side switches 240A or 240B. For any half-bridge that is phase-shifted, the other half-bridges of the secondary-side switches 240A and 240B are not phase-shifted and remain in-phase with the switching operation of the primary-side switch Q1 or Q2, leading to a phase-shift operation for one of the elemental transformers 212A or 212B.

The benefits of this selective phase-shift control of the power converter 108 include reduced frequency range of operation over an entire gain range while reducing SR turn-off loss. When the power converter 108 is switched at the resonant frequency (fₛ=fₒ), the mode II operation is present and occupies a significant fraction of the switching period. In mode II, the resonant tank 232 is charged slower than in mode IV, and the load 220 is disconnected, thereby making the mode II operation redundant in some cases. Therefore, the switching frequency fₛ can be increased to an optimal switching frequency fₒₚₜ to eliminate mode II. Unlike conventional methods, since mode IV also partially charges the load 220, the required frequency to achieve the same gain is reduced, thereby resulting in a lower frequency range for optimal efficiency. Thus, the selective phase-shift control of the power converter 108 also reduces its primary and secondary devices' driving losses and the SRs' turn-off losses.

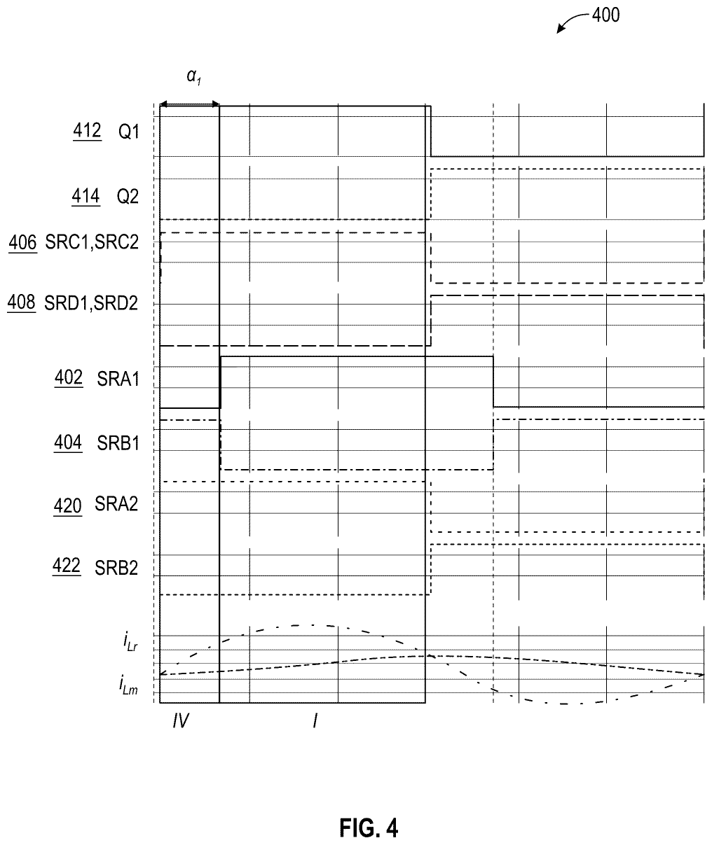

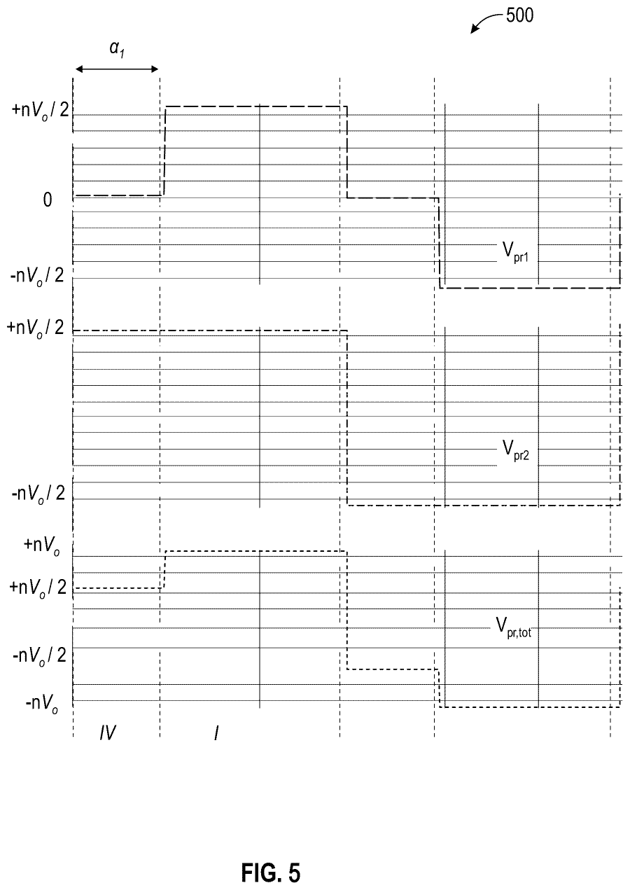

FIG. 4 depicts a waveform of switching operations of an example power converter implementing a first step of a hybrid selective SR phase-shift control method, and FIG. 5 depicts a waveform of respective voltage levels in an example power converter with respect to the switching operations shown in FIG. 4, according to various embodiments of the present disclosure. For example, waveform 400 depicts signals showing switching operations of the power converter 108 in the power converter system 100 implementing the hybrid selective SR phase-shift control method via switching control signals generated by the controller 101. In contrast to the selective SR phase control method corresponding to the waveform 300, the controller 101 can be configured to phase shift each elemental transformer 212A and 212B successively in a two-part method. The waveform 400 and waveform 500 (FIG. 5) correspond to an operating example of the power converter 108 where the power converter 108, including the transformer 212, is operating based on conditions where a switching frequency fₛ equals an optimal switching frequency (fₒₚₜ), although other operating frequencies of the power converter 108 can be relied upon and are included within the embodiments covered by this disclosure.

Referring to the waveform 400, the controller 101 is first configured to generate switching control signals for the power converter 108, such that switching operations of the secondary-side switches SRA1 and SRB1 (e.g., corresponding to the secondary-side switches 240A) are phase-shifted with respect to switching operations of the primary-side switches Q1 or Q2 (e.g., corresponding to the primary-side switches 233). In the period corresponding to mode “IV” shown in the waveform 400, switching operation 402 for the switch SRA1 and switching operation 404 for the switch SRB1 are phase-shifted with respect to switching operation with respect to switching operation 412 for the switch Q1. In other words, the switching operations 402 and 404 are phase-shifted by an angle of alpha (α₁) with respect to the switching operation 412, while switching operations 406 for the secondary-side switches SRC1 and SRC2, switching operations 408 for the secondary-side switches SRD1 and SRD2, switching operation 420 for the secondary-side switch SRA2, and switching operation 422 for the secondary-side switch SRB2 remain in phase with the switching operation 412.

To delineate further, the half-bridge corresponding to the secondary-side switches SRA1 and SRB1 is phase-shifted, while the other half-bridges in the transformer 212 are not phase-shifted. This first method of phase-shift control effectively phase-shifts operation of the elemental transformer 212A while the elemental transformer 212B is not phase-shifted, with respect to the primary-side switches 233. The phase-shift angle α₁ can range from 0-180°, which can cause the power converter 108 to achieve a max gain of 2 according to one example, but the power converter 108 is not limited thereto and can achieve other maximum gains depending on number of elemental transformers present.

This first step of the hybrid selective SR phase control method described above is similar to the control method described with respect to the waveform 300. For example, phase shifting the secondary-side switches SRA1 and SRB2 can cause the elemental transformer 212A to be effectively shorted during mode IV and cause a partial connection or selective connection of the load 220 via the elemental transformer 212B. Additionally, in mode IV, the load 220 can be charged via the partial connection or selective connection to the elemental transformer 212B, and the resonant tank 232 can be quickly charged as a result. In mode I, the load 220 and the resonant tank 232 can also be charged. After mode I, where modes IV-1 correspond to a half of a switching cycle, the controller 101 can be configured to generate switching control signals for the other half of the switching cycle for the primary-side switches 233 and the secondary-side switches 240A and 240B but in an inverted manner with respect to switching operation 414 for the primary-side switch Q2. Peak current (i_{LR}) for the series resonant inductor (Lᵣ) and peak current (i_{LM}) across the magnetizing inductor (Lₘ) can fluctuate as depicted in the waveform 400.

Referring now to the waveform 500 in FIG. 5, the voltage level (Vₚᵣ₁) corresponding to the voltage across the primary winding 214A is zero (0) in mode IV, resulting from the phase-shifting of the secondary-side switches SRA1 and SRB1 (e.g., corresponding to the secondary-side switches 240A), which effectively shorts the elemental transformer 212A during mode IV. The voltage level (Vₚᵣ₂) corresponding to the voltage across the primary winding 214B is nonzero and has a voltage of nVₒ/2 in mode IV, resulting from the partial connection or selective connection of the elemental transformer 212B based on the phase-shifting of the secondary-side switches SRA1 and SRB1. The voltage level (V_{pr,tot}) across the transformer 212 in mode IV is represented by (nVₒ/2) based on the partial or selective connection of the load 220 as described above.

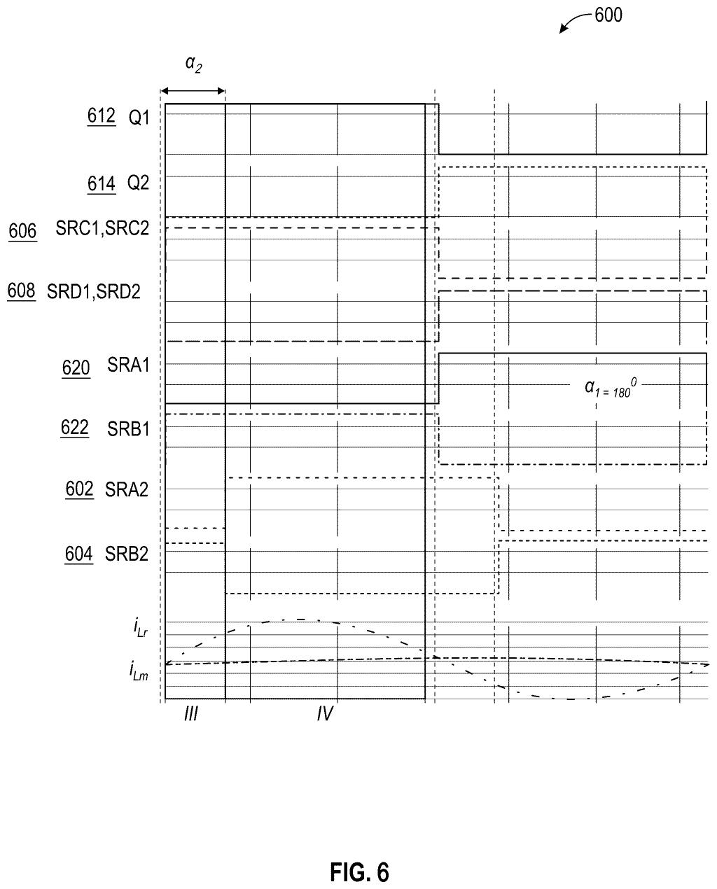

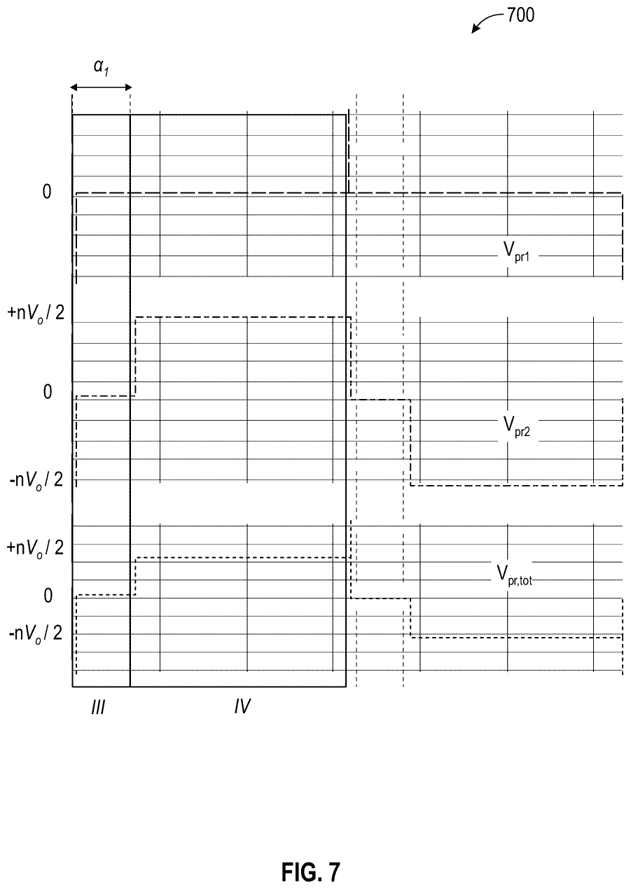

FIG. 6 depicts a waveform of switching operations of an example power converter implementing a second step of a hybrid selective SR phase-shift control method, and FIG. 7 depicts a waveform of respective voltage levels in an example power converter with respect to the switching operations shown in FIG. 6, according to various embodiments of the present disclosure. Waveforms 600 (FIGS. 6) and 700 (FIG. 7) correspond to an operating example of the power converter 108 where the power converter 108, including the transformer 212, is operating based on conditions where a switching frequency fₛ equals an optimal switching frequency fₒₚₜ, although other operating frequencies of the power converter 108 can be relied upon and are included within the embodiments covered by this disclosure.

After the first step is completed and the secondary-side switches SRA1 and SRB1 are phase-shifted with respect to the primary-side switches 233, which can include the secondary-side switches SRA1 and SRB1 being phase-shifted 180°, the controller 101 can be configured to phase-shift the secondary-side switches SRA2 and SRB2 (e.g., corresponding to the secondary-side switches 240B) to increase the gain beyond 2 (in this example). In other words, with respect to switching operation 612 of the primary-side switch Q1, switching operations 602 for the secondary-side switch SRA2 and switching operation 604 for the secondary-side switch SRB2 are phase-shifted by an angle of alpha (α₂) with respect to the switching operation 612, while switching operations 606 for the secondary-side switches SRC1 and SRC2, switching operations 608 for the secondary-side switches SRD1 and SRD2, switching operation 620 for the secondary-side switch SRA1, and switching operation 622 for the secondary-side switch SRB1 remain in phase with the switching operation 612.

To delineate further, the half-bridge corresponding to the secondary-side switches SRA2 and SRB2 is phase-shifted, while the other half-bridges in the transformer 212 are not phase-shifted. This second method of phase-shift control effectively phase-shifts operation of the elemental transformer 212B while the elemental transformer 212A is not phase-shifted within mode III, with respect to the primary-side switches 233. In mode III, both of the elemental transformers 212A and 212B are shorted causing complete disconnection of the load 220. The phase-shift angle α₂ can range from 0-180°, which can cause the power converter 108 to achieve a max gain of greater than 2 according to one example, but the power converter 108 is not limited thereto and can achieve other gains depending on the application of the power converter 108. The second part of the hybrid selective SR phase-shift control method described above is with respect to half of a switching cycle. The controller 101 can be configured to repeat the steps described above but in an inverted fashion with respect to switching operation 614, corresponding to the primary-side switch Q2. Peak current (i_{LR}) for the series resonant inductor (Lᵣ) and peak current (i_{LM}) across the magnetizing inductor (Lₘ) can fluctuate as depicted in the waveform 600.

Referring now to waveform 700 in FIG. 7, the voltage level (Vₚᵣ₁) corresponding to the voltage across the primary winding 214A is zero (0) in mode III, resulting from the phase-shifting of the secondary-side switches SRA2 and SRB2 (e.g., corresponding to the secondary-side switches 240B), which effectively disconnects the load 220. The voltage level (Vₚᵣ₂) corresponding to the voltage across the primary winding 214B is zero (0) in mode III, resulting from the disconnection of the load 220. The voltage level (V_{pr,tot}) across the resonant tank 232 in mode III is also zero (0) based on the disconnection of the load 220 in mode III.

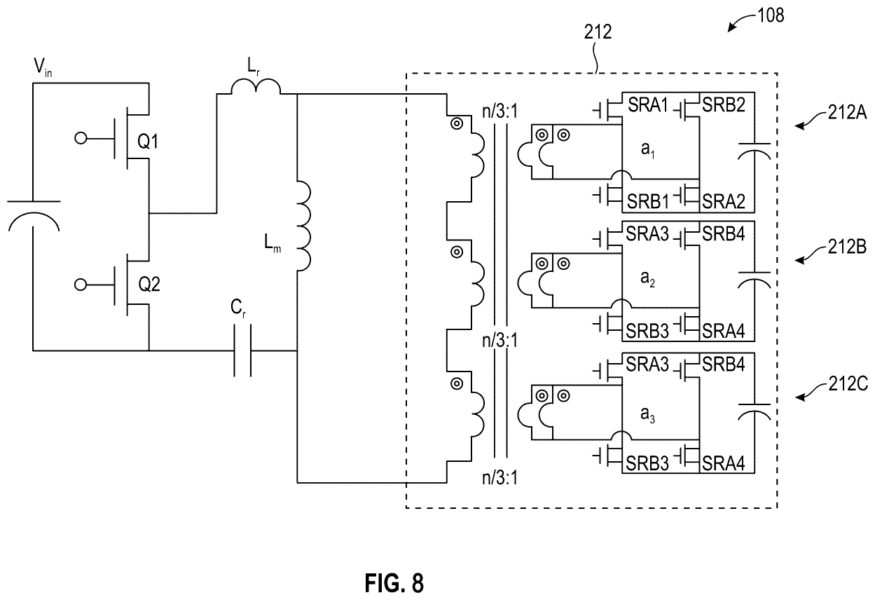

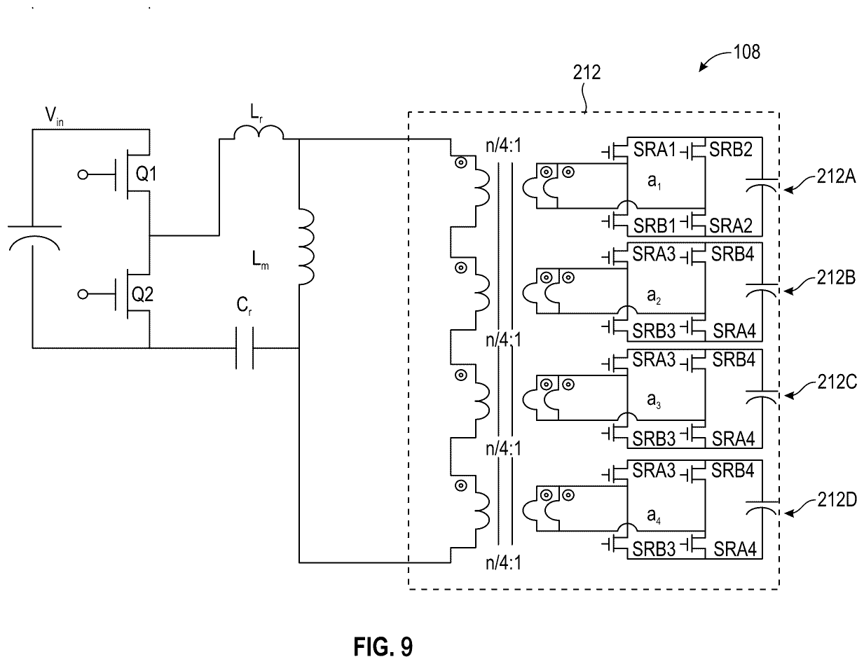

FIG. 8 depicts a schematic of an example power converter including three (3) elemental transformers that can be implemented in the system shown in FIG. 1, and FIG. 9 depicts a schematic of an example power converter including four (4) elemental transformers that can be implemented in the system shown in FIG. 1, according to various embodiments of the present disclosure. As discussed with respect to FIG. 2, the power converter 108 includes the transformer 212 with N elemental transformers. In the example shown in FIG. 8, the transformer 212 includes 3 elemental transformers 212A, 212B, and 212C, and in the example shown in FIG. 9, the transformer 212 includes 4 elemental transformers 212A, 212B, 212C, and 212D, in contrast with the 2 elemental transformers included for the transformer 212 in FIG. 2. Each of the elemental transformers 212A-212D includes SRs arranged as a full-bridge rectifier. With an increasing number N of elemental transformers, the turn ratio for the transformer 212 changes based on the number of elemental transformers as depicted.

The controller 101 can be configured to implement the hybrid selective SR phase-shift control method described above with respect to FIGS. 4-7 to each of the elemental transformers 212A-212C depicted in FIGS. 8 and 212A-212D depicted in FIG. 9. For example, each of the elemental transformers 212A-212C depicted in FIGS. 8 and 212A-212D depicted in FIG. 9 can be phase-shifted successively with respect to the operation of the primary-side switches 233. It should be noted that the number (N) of elemental transformers that can be included in the transformer 212 is not limited thereto and can include greater than 4 elemental transformers depending on the application of the power converter 108. Additionally, the hybrid-selective SR phase-shift control method can be implemented for each elemental transformer that is added to the transformer 212.

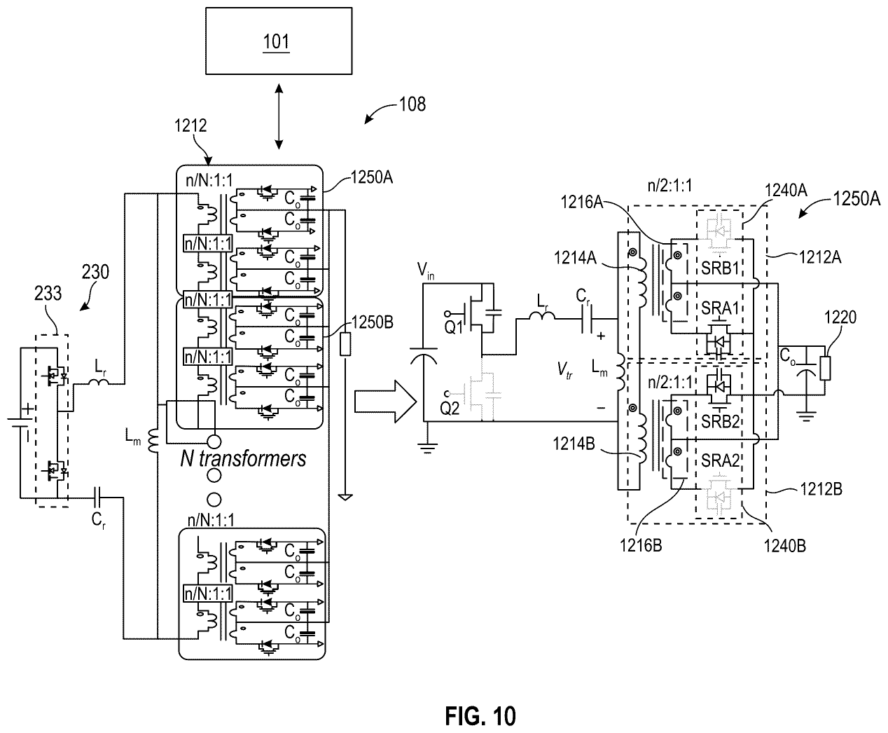

FIG. 10 depicts a schematic of an example power converter including a transformer with center-tapped rectifiers which can be implemented in the power converter system shown in FIG. 1, according to various embodiments of the present disclosure. The power converter 108 can include a transformer 1212 with N elemental transformers where at least two elemental transformers grouped together are referred to as a transformer group. For example, the transformer 1212 includes a transformer group 1250A, which includes two elemental transformers 1212A and 1212B. The transformer 1212 can include multiple transformer groups based on how many elemental transformers are included as part of the transformer 1212. For example, if the transformer 1212 includes N transformers, the transformer 1212 can have N/2 transformer groups. The controller 101 can be configured to generate switching control signals for each transformer group by implementing the selective SR phase-shift control method or the hybrid selective SR phase-shift control method discussed above.

Each elemental transformer includes two secondary-side switches connected to a secondary side of the transformer 1212, a primary winding connected to a primary side of the transformer 1212, and secondary windings connected to the secondary side of the transformer 1212. For example, the elemental transformer 1212A includes secondary-side switches 1240A, which include secondary-side SR switches SRB1 and SRA1. The elemental transformer 1212A also includes primary winding 1214A and secondary windings 1216A. The elemental transformer 1212B includes secondary-side switches 240B, which include secondary-side SR switches SRB2 and SRA2. The elemental transformer 1212B also includes primary winding 1214B and secondary windings 1216B. Each elemental transformer (e.g., the elemental transformer 1212A) is arranged as or forms a center-tap rectifier.

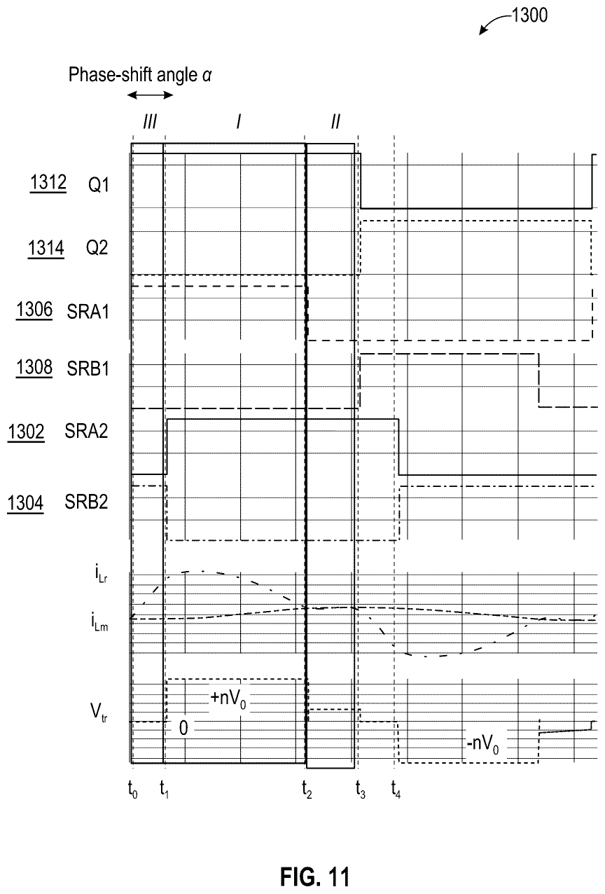

The transformer 1212 is configured to provide an output voltage to a load 1220 based on switching control signals received from the controller 101. The inverter 230 and the primary-side switches 233 are connected to the primary side of the transformer 1212 via the resonant tank 232. Each of the SRs (e.g., the secondary-side switches 1240A) of the elemental transformer 1250 can be embodied as MOSFETs or HEMTs. The transformer 1212 can have a turns ratio of n/N:1:1. As noted earlier, the controller 101 can be configured to generate switching control signals for controlling the switching operations of the transformer 1212. For example, the controller 101 can be configured to control switching operations of each elemental transformer (e.g., the elemental transformer 1212A) by implementing the selective SR phase-shift control method or the hybrid selective SR phase-shift control method. These control methods and implementation to the transformer 1212 are discussed further with respect to the waveform illustrated in FIG. 11.

FIG. 11 depicts a waveform of switching operations of an example power converter including a transformer with center-tap rectifiers, implementing a selective SR phase-shift control method, according to various embodiments of the present disclosure. For example, waveform 1300 can correspond to switching operations generated by the power converter 108 that includes the transformer 1212 shown in FIG. 10. The waveform 1300 depicts signals showing switching operations of the secondary-side switches 1240A and 1240B, switching operations of the primary-side switches 233, and impacted current and voltage levels in the power converter 108 based on the selective SR phase-shift control method. The waveform 1300 corresponds to an operating example of the power converter 108 where the power converter 108, including the transformer 1212, is operating based on conditions where a switching frequency fₛ equals the resonant frequency fₒ, although other operating frequencies of the power converter 108 can be relied upon and are included within the embodiments covered by this disclosure.

In the example shown according to the waveform 1300, the controller 101 can be configured to generate switching control signals for the power converter 108, such that switching operations of the secondary-side switches SRA2 and SRB2 (e.g., corresponding to the secondary-side switches 1240B) are phase-shifted with respect to switching operations of the primary-side switches Q1 or Q2 of the primary-side switches 233. In the period corresponding to mode “III” shown in the waveform 1300, switching operation 1302 for the switch SRA2 and switching operation 1304 for the switch SRB2 are phase shifted with respect to switching operation 1312 for the switch Q1. In other words, the switching operations 1302 and 1304 are phase-shifted by an angle of alpha (α) with respect to the switching operation 1312, while switching operations 1306 and 1308 for the secondary-side switches SRA1 and SRB1 (e.g., corresponding to the secondary-side switches 1240A) are in-phase with the switching operation 1312.

This selective SR phase-shift control method applied to the transformer 1212 can cause a similar operation as to the operation of the power converter 108 in FIG. 2 with the transformer 212, which includes elemental transformers operating as full-bridge rectifiers. For example, similar to the control of the transformer 212, operation of each elemental transformer can be phase-shifted with respect to the operation of the primary-side switches 233. Although the waveform 1300 exemplifies a phase-shift operation of the elemental transformer 1212B by way of phase shifting the secondary-side switches 1240B, the controller 101 can be configured to phase shift the elemental transformer 1212A instead of 1212B, and similarly with each transformer group of the transformer 1212. The phase-shift angle α can range from 0-180°, which can cause the power converter 108 to achieve a max gain of 2 according to one example, but the power converter 108 is not limited thereto and can achieve other gains.

This mode of operation and selective SR phase-shifting can cause the voltage (Vₜᵣ) across the transformer group 1250A to cancel out to zero in mode III (e.g., t₀−t₁) by way of equal but opposite polarity voltages for the elemental transformer 1212A and the elemental transformer 1212B. After mode III, the power converter 108 can be configured to operate in mode I (e.g., t₁−t₂) and in mode II (e.g., t₂−t₃) thereafter. Current (i_{LR}) represents peak current across the series resonant inductor (Lᵣ) and current (i_{LM}) represents peak current across the magnetizing inductor (Lₘ) for the different modes of operation of the power converter 108. By implementing the selective phase-shift control described above, peak currents across the series resonant inductor Lᵣ can be reduced and charging of the load 220 can be controlled. After mode II, the controller 101 can be configured to generate switching control signals for the other half of the switching cycle for the primary-side switches 233 and the secondary-side switches 1240A and 1240B but in an inverted manner (e.g., selectively phase shifting with respect to switching operation 1314 of the switch Q2), while implementing selective phase-shift control of one elemental transformer 1212A or 1212B.

It should be noted that the hybrid selective SR phase-shift control method described with respect to the power converter 108 and the transformer 212 can also be applied to the transformer 1212 with center-tap rectifiers. For example, after the phase-shifting of the operation of the elemental transformer 1212B of group 1250A by (α) of 180°, which can correspond to a first step of the hybrid selective SR phase-shift control method, the controller 101 can be configured to perform a similar phase shift operation on transformer group 1250B with respect to the operation of the primary-side switches 233, which can correspond to a second step of the hybrid selective SR phase-shift control method. This method of applying the hybrid selective SR phase-shift control method to the transformer groups 1250A, 1250B, etc., with center-tap rectifiers is similar to the successive phase shifting of each elemental transformer in the transformer 212 with respect to the hybrid selective SR phase-shift control method described above with respect to FIGS. 4-7. This successive method of phase shifting each elemental transformer can be applied to each transformer group (e.g., the transformer group 1250A, the transformer group 1250B, etc.) for the transformer 1212. Application of the hybrid selective SR phase-shift control method for the transformer 1212 can cause the power converter 108 to achieve a max gain of greater than N/(N−1) according to one example, but the power converter 108 is not limited thereto and can achieve other gains depending on the application of the power converter 108.

The selective SR phase-shift control method and the hybrid selective SR phase-shift control method described herein with respect to the transformers (e.g., the transformer 212 and the transformer 1212) that include full-bridge SRs and center-tap SRs can provide reduced frequency range operation over an entire gain range, increase longevity of the SRs and other components of the power converter such as the resonant tank, and decrease switching losses. Combined with the performance driven and energy hungry applications that are continuously being developed today, the control methods described herein can boost performance and reliability of interconnected components within a power conversion system.

One or more microprocessors, microcontrollers, or DSPs can execute software to perform the control aspects of the embodiments described herein, such as the control aspects performed by the controller 101. Any software or program instructions can be embodied in or on any suitable type of non-transitory computer-readable medium for execution. Example computer-readable mediums include any suitable physical (i.e., non-transitory or non-signal) volatile and non-volatile, random and sequential access, read/write and read-only, media, such as hard disk, floppy disk, optical disk, magnetic, semiconductor (e.g., flash, magneto-resistive, etc.), and other memory devices. Further, any component described herein can be implemented and structured in a variety of ways.

For example, one or more components can be implemented as a combination of discrete and integrated analog and digital components.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A power converter system, comprising:
an input and an output;
a power converter between the input and the output, the power converter comprising:
a transformer comprising N elemental transformers;
primary-side switches coupled to a primary side of the transformer and operating based on a primary-side switching operation; and
secondary-side switches coupled to each elemental transformer among the N elemental transformers at a secondary side of the transformer; and
a controller configured to generate switching control signals for the secondary-side switches such that a switching operation in at least one elemental transformer among the N elemental transformers is phase-shifted with respect to the primary-side switching operation, wherein a switching operation in at least one other elemental transformer among the N elemental transformers is in-phase with respect to the primary-side switching operation.

2. The power converter system of claim 1, wherein for the switching operation in the at least one elemental transformer, the controller is further configured to:
phase shift a switching operation of a half-bridge of the at least one elemental transformer with respect to the primary-side switching operation.

3. The power converter system of claim 2, wherein for the switching operation in the at least one elemental transformer, the controller is further configured to:
cause a switching operation of the other half-bridge to be in-phase with respect to the primary-side switching operation.

4. The power converter system of claim 1, wherein for the switching operation of the at least one elemental transformer, the output is selectively connected to the power converter via the at least one different elemental transformer and shorted via the at least one elemental transformer.

5. The power converter system of claim 1, wherein to generate the switching control signals for the secondary-side switches, the controller is further configured to phase shift in the at least one elemental transformer, with respect to the primary-side switching operation, using a phase-shift angle that ranges from greater than 0° to less than or equal to 180°.

6. The power converter system of claim 1, wherein the controller being configured to generate the switching control signals for each secondary-side switches causes a reduced frequency range operation for the power converter while providing a higher gain for the output.

7. The power converter system of claim 1, wherein:
the power converter is a resonant LLC converter; and
the transformer is a matrix transformer.

8. The power converter system of claim 7, wherein the resonant LLC converter comprises a resonant tank, the resonant tank comprising:
a series resonant inductor (Lr); and
a resonant capacitor (Cr), wherein a voltage across the resonant tank corresponding to the switching operation in the at least one elemental transformer is reduced as compared to an operation where the output is shorted from the power converter.

9. The power converter system of claim 1, wherein the secondary-side switches coupled to each elemental transformer form a full-bridge rectifier.

10. The power converter system of claim 1, wherein the secondary-side switches coupled to each elemental transformer form a center-tap rectifier.

11. The power converter system of claim 10, wherein:
the at least one elemental transformer comprises a first plurality of elemental transformers among the N elemental transformers; and
the at least one other elemental transformer comprises a second plurality of elemental transformers among the N elemental transformers, the second plurality being different from the first plurality.

12. The power converter system of claim 1, wherein the secondary-side switches coupled to each elemental transformer are connected in series to the output.

13. A power converter system, comprising:
a power converter comprising:
a transformer comprising N elemental transformers;
primary-side switches coupled to a primary side of the transformer and operating based on a primary-side switching operation; and
secondary-side switches coupled to each elemental transformer among the N elemental transformers at a secondary side of the transformer; and
a controller configured to generate switching control signals for the secondary-side switches such that:
a switching operation in at least one elemental transformer among the N elemental transformers is phase-shifted with respect to the primary-side switching operation, wherein a switching operation in at least one other elemental transformer among the N elemental transformers is in-phase with respect to the primary-side switching operation; and
a switching operation in the at least one other elemental transformer is phase-shifted with respect to the primary-side switching operation, wherein a switching operation in the at least one elemental transformer is in-phase with respect to the primary-side switching operation.

14. The power converter system of claim 13, wherein:
for the switching operation in the at least one elemental transformer, the controller is further configured to phase shift a switching operation of a half-bridge of the at least one elemental transformer with respect to the primary-side switching operation; and
for the switching operation in the at least one other elemental transformer, the controller is further configured to phase shift a switching operation of a half-bridge of the at least one other elemental transformer with respect to the primary-side switching operation.

15. The power converter system of claim 14, wherein:
for the switching operation in the at least one elemental transformer, the controller is further configured to cause a switching operation of the other half-bridge of the at least one elemental transformer to be in-phase with respect to the primary-side switching operation; and
for the switching operation in the at least one different elemental transformer, the controller is further configured to cause a switching operation of the other half-bridge of the at least one different elemental transformer to be in-phase with respect to the primary-side switching operation.

16. The power converter system of claim 13, wherein the output is shorted from the power converter during the switching operation in the at least one different elemental transformer.

17. The power converter of claim 13, wherein the controller is further configured to cause the switching operation in the at least one different elemental transformer to execute after the switching operation in the at least one elemental transformer has been phase-shifted, with respect to the primary-side switching operation, using a phase-shift angle that ranges from greater than 0° to less than or equal to 180°.

18. The power converter system of claim 13, wherein the secondary-side switches coupled to each elemental transformer form a full-bridge rectifier.

19. The power converter system of claim 13, wherein the secondary-side switches coupled to each elemental transformer form a center-tap rectifier.

20. The power converter system of claim 19, wherein:
the at least one elemental transformer comprises a first plurality of elemental transformers among the N elemental transformers; and
the at least one different elemental transformer comprises a second plurality of elemental transformers among the N elemental transformers, the second plurality being different from the first plurality.
